(19) United States
(12) Patent Application Publication
(10) Pub. No.: US 2011/0083451 A1
(43) Pub. Date: Apr. 14, 2011

(54) CONTROL METHOD FOR AIR CONDITIONER OF VEHICLE

(75) Inventors: Chunkyu Kwon, Hwaseong-si (KR); Changwon Lee, Hwaseong-si (KR); Kilyong Jang, Hwaseong-si (KR)

(73) Assignees: Hyundai Motor Company, Seoul (KR); Kia Motors Company, Seoul (KR)

(21) Appl. No.: 12/870,108

(22) Filed: Aug. 27, 2010

(30) Foreign Application Priority Data
Oct. 8, 2009 (KR) 10-2009-0095508

(51) Int. Cl. B60H 1/32

(52) U.S. Cl. 62/61

(57) ABSTRACT

Ensuring driving performance of a vehicle and improving fuel efficiency is made possible by appropriately controlling capacity of an air-con compressor, while stably maintaining cooling performance to provide comfortable circumstances for passengers.

### CROSS-REFERENCE TO RELATED APPLICATIONS

The present application claims priority to Korean Patent Application Number 10-2009-0095508 filed Oct. 8, 2009, the entire contents of which application is incorporated herein for all purposes by this reference.

### BACKGROUND OF THE INVENTION

1. Field of the Invention

The present invention relates to a control method for an air conditioner of a vehicle, in more detail a control method for an air conditioner that implements improving comfortability for passengers and driving performance and fuel efficiency of vehicles, in vehicles equipped with an air conditioner including a variable capacity compressor changing the volume of discharged coolant by compressing it.

2. Description of Related Art

An air conditioner is provided in vehicles to providing comfortable circumstances for passengers and generally includes an air-con for cooling and a heater for heating.

The air-con compresses coolant with a compressor and should use power from the engine to drive the compressor, as described above. Therefore, whether to driving the compressor and the capacity of the compressor have a great influence on fuel efficiency and driving performance of vehicles.

Accordingly, there has been proposed compressors that are designed to improve driving performance and fuel efficiency of vehicles by changing capacity, if necessary.

However, reducing capacity of a compressor to improve driving performance and fuel efficiency of vehicles may make passengers uncomfortable, because the cooling performance of the air-con decreases.

The information disclosed in this Background section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a control method for an air conditioner of a vehicle which can ensure driving performance of the vehicle and improve fuel efficiency by appropriately controlling capacity of an air-con compressor, while stably maintaining cooling performance to provide comfortable circumstances for passengers.

An aspect of the present invention provides a control method for an air conditioner of a vehicle which includes: determining whether a vehicle is being accelerated; comparing evaporator temperature with allowable comfortable temperature, when determining that the vehicle is being accelerated; reducing capacity of a compressor, when the evaporator temperature is lower than the allowable comfortable temperature; comparing the evaporator temperature with desired evaporator temperature; and decreasing the amount of air passing through a heater core after passing through the evaporator, when the evaporator temperature is higher than the desired evaporator temperature.

According to the present invention, it is possible to ensure driving performance of the vehicle and improve fuel efficiency by appropriately controlling capacity of an air-con compressor, while stably maintaining cooling performance to provide comfortable circumstances for passengers.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a flowchart illustrating an exemplary control method for an exemplary air conditioner of a vehicle according to the present invention.

FIG. 2 is a diagram showing an example of a two-dimensional map with a defined functional relationship between the number of revolution of an engine and throttle position sensor signal.

FIG. 3 is a diagram illustrating rotation of an exemplary temperature control door.

FIG. 4 is a flowchart illustrating an exemplary control method for an exemplary air conditioner of a vehicle according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

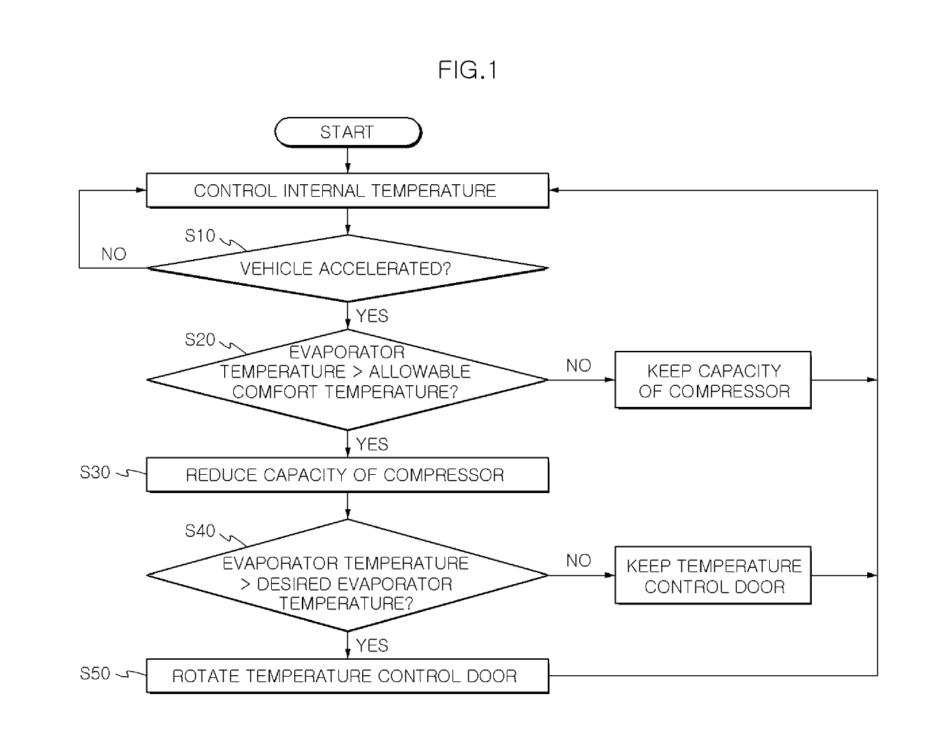

Referring to FIG. 1, a control method for an air conditioner of a vehicle according to various embodiments of the present invention includes: determining whether a vehicle is being accelerated (S10); comparing evaporator temperature with allowable comfortable temperature, when determining that the vehicle is being accelerated (S20); reducing capacity of a compressor, when the evaporator temperature is lower than the allowable comfortable temperature (S30); comparing the evaporator temperature with desired evaporator temperature (S40); and decreasing the amount of air passing through a heater core after passing through the evaporator, when the evaporator temperature is higher than the desired evaporator temperature (S50).

That is, the method was designed to monitor acceleration of a vehicle while controlling the internal temperature of the vehicle as in the related art and ensure driving performance, that is, acceleration performance of a vehicle by reducing capacity of the compressor in accordance with degree of the acceleration. Further, the method was designed to ensure comfortability by reducing the amount of air passing through the heater core by operating a temperature control door to maintain cooling performance for the inside of the vehicle, when evaporator temperature becomes higher than desired evaporator temperature.

Improvement of fuel efficiency of the vehicle depends on the control of the compressor and the adjustment of the temperature control door, as described above.

In this configuration, the desired evaporator temperature is predetermined temperature that the evaporator should reach in accordance with internal temperature set by a passenger.

The determining whether a vehicle is being accelerated (S10) receives the revolution speed of the engine and a signal of a throttle position sensor, and then determines whether the vehicle is being accelerated on the basis of the received number of revolution of the engine and the position of the throttle position sensor signal in a two-dimensional map with a defined functional relationship between the revolution speed of the engine and the throttle position sensor signal.

At least two functional relationships for the degree of acceleration of the vehicle are stored in the two-dimensional map with a defined functional relationship between the revolution speed of the engine and the throttle position sensor, such that the determining whether a vehicle is being accelerated (S10) discriminates acceleration of the vehicle into at least two statuses or more, in accordance with the revolution speed of the engine and the signal of the throttle position sensor.

In this case, the comparing evaporator temperature with predetermined allowable comfort temperature (S20) differently applies the allowable comfort temperature in accordance with the acceleration of the vehicle divided into two statuses or more and the allowable comfort temperature for relatively large acceleration in the statuses is set larger than the allowable comfort temperature for the relatively small acceleration.

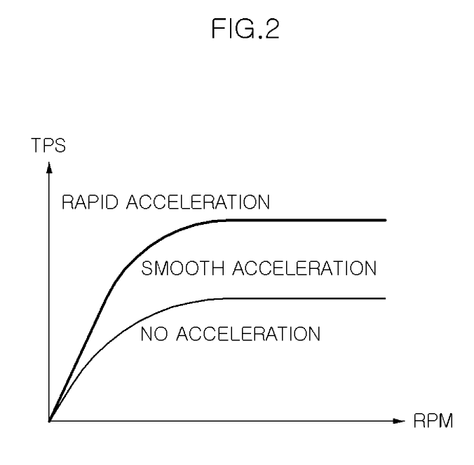

As an example, as shown in FIG. 2, when a functional relationship about rapid acceleration of a vehicle and a functional relationship about smooth acceleration are stored in the two-dimensional map with a defined functional relationship between the revolution speed of the engine and a throttle position sensor signal, the determining whether a vehicle is being accelerated (S10) discriminates whether the vehicle is being rapidly or smoothly accelerated on the basis of the revolution speed of the engine and the throttle position sensor signal, and the comparing of evaporator temperature with predetermined allowable comfort temperature (S20) differently applies the allowable comfort temperature such that the allowable comfort temperature for the rapid acceleration is larger than the allowable comfort temperature for the smooth acceleration, in accordance with whether the vehicle is being rapidly or smoothly accelerated.

The allowable comfort temperature is temperature as high as possible to be expected to make passengers comfort. For example, the allowable comfort temperature may be set to 10° C. when the vehicle is rapidly accelerated, and to 8° C. when the vehicle is smoothly accelerated.

The reducing of capacity of a compressor (S30) reduces capacity of the compressor in proportion to a difference between the allowable comfort temperature and the evaporator temperature.

When the capacity of the compressor is controlled on the basis of the duty value of control current, the capacity is reduced by controlling the compressor on the basis of a value obtained by subtracting a value, which is obtained by the difference between the allowable comfort temperature and the evaporator temperature by a duty conversion factor, from the previous duty value, in the reducing capacity of a compressor (S30).

That is, the duty D to applied to the compressor to reduce the capacity of the compressor is determined by,

D=D_OLD−a×(allowable comfort temperature−evaporator temperature)

where, D_OLD is previous control duty of the compressor and a is a duty conversion factor for converting the temperature difference into control duty of the compressor.

The decreasing of the amount of air passing through a heater core after passing through the evaporator (S50) decreases the amount of air passing through the heater core after passing through the evaporator, in proportion to a difference between the desired evaporator temperature and the evaporator temperature.

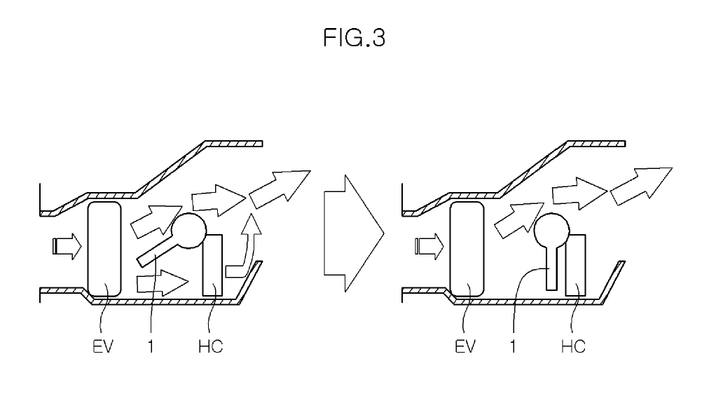

As shown in FIG. 3, when the amount of air passing through the heater core HC after passing through the evaporator EV is adjusted on the basis an angle of a temperature control door 1 rotating in the direction of blocking the heater core HC between the evaporator EV and the heater core HC, temperature control door 1 is further rotated from the previous angle, at which temperature control door 1 has rotated, in the direction of blocking the heater core HC, to an angle obtained by multiplying the difference between the desired evaporator temperature and the evaporator temperature by an angle conversion factor, in the reducing of the amount of air passing through the heater core HC after passing through the evaporator EV.

That is, the rotational angle E of temperature control door 1 is determined by,

E=E_OLD+b×(desired evaporator temperature−evaporator temperature)

where, E_OLD is the previous rotational angle of temperature control door 1 and b is an angle conversion factor for converting the temperature difference into rotational angle of temperature control door 1.

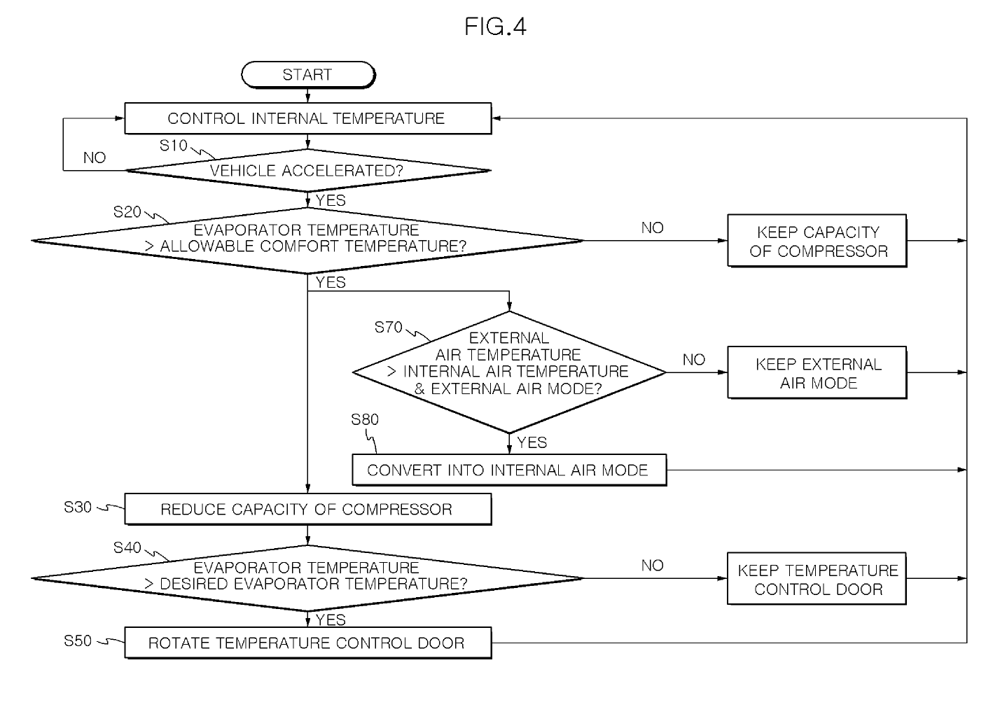

As shown in FIG. 4, the method may further includes: determining whether a vehicle is in an external air mode and comparing the temperature of the external air and the internal air of the vehicle (S70); and converting the mode into an internal air mode (S80), when the vehicle is in the external air mode and the external air is higher in temperature than the internal air, in reducing the capacity of the compressor on the basis of the determined acceleration status of the vehicle.

That is, in the external air mode, the mode is converted into the internal air mode when the internal air is lower in temperature than the external air as a result of comparing the temperature of the external air and the internal air, in order to improve fuel efficiency of the vehicle by continuing as long as possible the reduction of capacity of the compressor, when the capacity of the compressor is reduced with the vehicle being accelerated.

It is possible to partially convert the external air mode into the internal air mode, and as the external mode is converted into the internal air mode, as described above, it is possible to keep the reduction of capacity of the compressor and maintain comfortable circumstances for a long time in the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method for an air conditioner having an evaporator of a vehicle having an engine, comprising:
determining whether a vehicle is being accelerated;
comparing an evaporator temperature with an allowable comfortable temperature when the vehicle is being accelerated;
reducing capacity of a compressor, when the evaporator temperature is lower than the allowable comfortable temperature;
comparing the evaporator temperature with a desired evaporator temperature; and
decreasing the amount of air passing through a heater core after passing through the evaporator, when the evaporator temperature is higher than the desired evaporator temperature.

2. The control method as defined in claim 1, wherein the determining whether a vehicle is being accelerated step includes obtaining a revolution speed of the engine and a throttle position sensor signal, and determining whether the vehicle is being accelerated based on the revolution speed of the engine and a position of the throttle position sensor signal in a two-dimensional map with a defined functional relation ship between the revolution speed of the engine and the throttle position sensor signal.

3. The control method as defined in claim 2, wherein at least two functional relationships for the degree of acceleration of the vehicle are stored in the two-dimensional map with a defined functional relationship between the revolution speed of the engine and the throttle position sensor, such that the determining whether a vehicle is being accelerated categorizes acceleration of the vehicle into at least two modes, in accordance with the revolution speed of the engine and position of the throttle position sensor.

4. The control method as defined in claim 3, wherein the comparing evaporator temperature with predetermined allowable comfort temperature step selectively applies the allowable comfort temperature in accordance with the acceleration of the vehicle divided into at least two modes, and the allowable comfort temperature for relatively large acceleration in a first mode is set larger than the allowable comfort temperature for relatively small acceleration in a second mode.

5. The control method as defined in claim 4, wherein a first functional relationship for rapid acceleration of a vehicle and a second functional relationship for smooth acceleration are stored in the two-dimensional map with a defined functional relationship between the revolution speed of the engine and the throttle position sensor signal,
the determining whether a vehicle is being accelerated categorizes whether the vehicle is being rapidly or smoothly accelerated on the basis of the revolution speed of the engine and the throttle position sensor signal, and
the comparing of evaporator temperature with predetermined allowable comfort temperature differently applies the allowable comfort temperature such that a first allowable comfort temperature for rapid acceleration is larger than a second allowable comfort temperature for smooth acceleration, in accordance with whether the vehicle is being rapidly or smoothly accelerated.

6. The control method as defined in claim 1, wherein the reducing of capacity of a compressor step reduces capacity of the compressor in proportion to a difference between the allowable comfort temperature and the evaporator temperature.

7. The control method as defined in claim 6, wherein when the capacity of the compressor is controlled on the basis of a duty value of a control current, the capacity is reduced by controlling the compressor on the basis of a value obtained by subtracting a value, which is obtained by the difference between the allowable comfort temperature and the evaporator temperature by a duty conversion factor, from the previous duty value, in the reducing capacity of a compressor.

8. The control method as defined in claim 1, wherein the decreasing the amount of air passing through a heater core after passing through an evaporator step reduces the amount of air passing through the heater core after passing through the evaporator in proportion to a difference between the desired evaporator temperature and the evaporator temperature.

9. The control method as defined in claim 8, wherein when the amount of air passing through the heater core after passing through the evaporator is adjusted on the basis an angle of a temperature control door rotating in a direction of blocking the heater core between the evaporator and the heater core, the temperature control door is further rotated from the previous angle, at which temperature control door has rotated, in the direction of blocking the heater core, to an angle obtained by multiplying the difference between the desired evaporator temperature and the evaporator temperature by an angle conversion factor, in the reducing of the amount of air passing through the heater core after passing through the evaporator.

10. The control method as defined in claim 1, further comprising: determining whether a vehicle is in an external air mode and comparing the temperature of the external air with the internal air of the vehicle; and
converting the mode into an internal air mode, when the vehicle is in the external air mode and the external air is higher in temperature than the internal air, in reducing the capacity of the compressor on the basis of the determined acceleration status of the vehicle.
